(19) United States
(12) Patent Application Publication
(10) Pub. No.: US 2005/0133949 A1
(43) Pub. Date: Jun. 23, 2005

(54) Polymer solidification and coating process

(75) Inventor: George P. Stoy, Boro of Rocky Hill, NJ (US)

Correspondence Address: Kenneth P. Glynn, Esq.;Glynn & Associates, P.C., 24 Mine Street, Flemington, NJ, 08822, US

(73) Assignee: PragTech, Inc.

(21) Appl. No.: 10/740,960

(22) Filed: Dec. 19, 2003

(51) Int. Cl. B29C 47/00

(52) U.S. Cl. 264/176.1; 264/319; 264/299

(57) ABSTRACT

The present invention relates to a process for creating a polymer film or coating. It includes the steps of: (a) creating a polymer solvent solution at an elevated temperature in excess of 65 degrees Centigrade by combining a polymer, especially a polymer containing a majority of polymer that is polyacrylonitrile, and most especially all polyacrylonitrile, and a solvent selected from the group consisting of dimethyl sulfoxide, dimethyl formamide, NaSCN, CaSCN, nitric acid, ethylene carbonate and mixtures thereof; (b) cooling the resulting solution to a temperature below 35 degrees Centigrade; (c) adding a nonsolvent liquid to said solution, said nonsolvent being selected from the group consisting of water, miscible liquid carbon compounds that do not dissolve said polymer, and combinations thereof: and (d) extracting said solvent and said nonsolvent from said solution to yield a solid polymer film. Preferably, the solution is created having an amount of at least 5%, by weight, of polymer, based on the total weight of the solution of polymer and solvent, and the solution is applied to a substrate before, during or after the cooling step to create a coating.

### INCORPORATION BY REFERENCE

U.S. Pat. No. 6,593,451 B1 entitled “METHOD OF PROCESSING POLYACRYLONITRILE”, to the same inventor as in the present case and to the same assignee, and issued on Jul. 15, 2003, is incorporated herein by reference in its entirety.

### BACKGROUND OF THE INVENTION

1. Field of the Invention

The present invention relates to polymer coatings and films, and particularly to a process for creating polymer coatings and films (film encompassing a freestanding item as well as an attached item, and a coating being a type of film that is somehow attached to or adhered to a substrate). The present invention process eliminates solvent pollution and wasted monomer that may occur in prior methods.

2. Information Disclosure Statement

The following patents are representative of the art relating to processing of polyacrylonitrile and products resulting therefrom:

U.S. Pat. No. 4,369,294 discloses block copolymers having acrylonitrile sequences and sequences of glutarimide units of a molecular weight of from about 10,000 to about 2,000,000 where the acrylonitrile sequences and sequences including glutarimide units are of molecular weight of at least about 400 with the number of sequences being at least about 2 and preferably 5 and higher.

U.S. Pat. No. 4,731,078 describes an artificial intraocular lens that features an optical body for refracting images onto the retina and an outer surface that encloses that optical body, is exposed to fluid within the eye, and has a refractive index no greater than 1.40. In another aspect, the optical body includes an internal refractive surface whose contour can be selectively changed to change its refractive power.

U.S. Pat. No. 4,731,079 describes a novel intraocular lens and mode of insertion therefore. The lens is of conventional shape and dimensions but is made of polymeric material having a softening point in the range of body temperature. The lens, prior to insertion is dimensionally reduced to enable introduction through a small incision by compression or by axial extension. The deformed lens is frozen in this configuration by cooling the lens below its softening temperature. The cooled, deformed lens is then inserted into the eye. The action of body heat, optionally supplemented by various non-harmful methods, permits the lens to regain its original configuration within the eye.

U.S. Pat. No. 4,943,618 describes a method that is disclosed for preparing polyacrylonitrile copolymers by Heterogeneous reaction of polyacrylonitrile aquagel. Generally, the method includes the steps of preparing a solution of polyacrylonitrile by dissolving the polyacrylonitrile in a water-miscible solvent which is capable of dissolving the polyacrylonitrile but incapable of hydrolyzing the nitrile groups of the polyacrylonitrile but incapable of hydrolyzing the nitrile groups of the polyacrylonitrile under the dissolution conditions. Coagulating the polyacrylonitrile solution by replacing the solvent with a coagulating fluid such as water or a water miscible fluid incapable of dissolving polyacrylonitrile at temperatures below 80° C., and incapable of reacting with nitrile groups of the polyacrylonitrile, thus obtaining the polymer in the aquagel state. Replacing the coagulating fluid with a fluid reagent capable of reacting with nitrile groups of the polyacrylonitrile aquagel but incapable of dissolving the polyacrylonitrile aquagel at the selected reaction temperature. Allowing the fluid reagent to chemically react with the nitrile groups of the aquagel while the polyacrylonitrile aquagel is undissolved to form a copolymer product. The copolymer product is then either used in further chemical reactions involving newly formed and/or original side substituents, or isolated and utilized for molding or shaping into various articles. Various plasticizers, which when undiluted are capable of dissolving polyacrylonitrile, may be added to the copolymer product to assist in molding or shaping the material into an article.

U.S. Pat. No. 5,149,052 describes a method and apparatus for precision molding soluble polymers is disclosed, in order to form an exact and precisely shaped product, such as contact lenses and surgical implants. A preferred mold for forming contact lenses includes a female part having an indentation and a sharp circumferential edge surrounding the indentation. The mold also includes a male part which is adapted to contact the sharp circumferential edge of the female part to form the molding cavity between the indentation of the female part and the male part. A semi-permeable gate is formed between the female part and the male part for introducing coagulating fluid into the molding cavity while preventing the escape of the polymer solution from the molding cavity. The semi-permeable gate allows the diffusion of the coagulating fluid into the molding cavity at a faster rate than the rate of diffusion of solvent out of the molding cavity. The polymer solution is coagulated by the influx of the coagulating fluid into the polymer solution which causes both the coagulation and swelling of the polymer solution. Swelling of the polymer solution coagulates the solution under pressure within the molding cavity to form a precisely shaped product. Coagulation proceeds under pressure since the solvent diffuses out of the semi-permeable gate at a slower rate than the diffusion of the coagulating fluid into the molding cavity.

U.S. Pat. No. 5,159,360 describes a contact lens that is a soft, disposable lens which, under eye wearer conditions, changes one or more characteristics essential for comfortable use, at a predetermined time to initiate disposal thereof by the user. This lens, under wear conditions, changes, for example, at least its base curve redius and its deformability as a consequence of a change in hydrophilicity of at least a portion of the contact lens material. This hydrophilicity change may be achieved by various means, e.g. degradation of crosslinking bridges or conversion of less hydrophilic groups to groups having greater hydrophilicity. In one preferred embodiment, the conversion is achieved by hydrolysis of selected functional (hydrophobic) groups into hydrophilic groups.

U.S. Pat. No. 5,217,026 describes a guidewire that involves an elongated, non-hydrogel core element forming an inner part of the device, and an integral outside tubular layer of elastomeric hydrogel (“hydrogel sleeve”). This outer hydrogel layer has unique physical characteristics. They are (a) Gradient of chemical composition with increasing concentration of polar groups in the outward direction away from the core element; (b) Gradient of swelling in contact with water with water content increasing in the outward direction away from the core element; (c) Compressive stress in the outer hydrophilic layer causing the hydrogel in that layer to swell to a water content and, optionally, (d) Inward-directed radial stress pushing the outside hydrogel layer constantly against the inner core element. The present invention also involves the methods of making these guidewires, including melt extrusion directly onto the core element, coagulation from solution, in situ hydrogel polymer formation, and tubing extrusion followed by consequent shrink-fit over the core.

U.S. Pat. No. 5,218,039 describes stable emulsions and dispersions of both the water-in-oil and oil-in-water types that are prepared by subjecting mixtures of the two phases to shear stress in the presence of nitrile group-containing copolymers capable of forming hydrogels containing at least 90%, by weight, of water at room temperature.

U.S. Pat. No. 5,368,048 describes a method of making a radio-opaque tipped, sleeved guidewire. It includes providing a bendable core piece of a predetermined length, having a control end and having a predetermined core diameter, and providing a shrinkable polymeric sleeve formed of a first polymer composition having a first diameter at least as large as said core diameter and having a second, smaller diameter from shrinking said second diameter, which is less than said core diameter. The polymeric sleeve is placed over the core piece while the polymeric sleeve has its first diameter, so as to have one end of the polymeric sleeve cover at least a portion of the distal end of the core piece. Next, a mixture of a radio-opaque metal powder and a second polymer composition is provided. The second polymer composition is capable of forming a physical bond with the first polymeric composition of the polymeric sleeve. The mixture is inserted into the overhanging polymeric sleeve at the distal end of the core piece and the polymeric sleeve is shrunk to its second, smaller diameter. The physical bond is formed between the first polymer composition and the second polymer composition. The present invention is also directed to the resulting guidewire products.

The following patents are representative of artificial joint patents:

U.S. Pat. No. 4,944,758 describes an artificial joint comprising a first member including a butt portion located at one end of the first member and having an internal opening and a long guide groove extending to the opening and a second member in contact with the butt portion of the first member and including an expanded portion at one end of the second member. The expanded portion is fitted in the internal opening of the first member. A projection along both sides of the long guide groove prevents the expanded portion from separating from the internal opening except at prescribed positions of the first and second members, the long guide groove guides the movement of the second member as it bends relative to the first member in a prescribed direction.

U.S. Pat. No. 5,092,896 describes a finger joint prosthesis that is provided which consists of two pegs of sintered hydroxylapatite for anchoring in adjacent finger bones and which is provided with an intermediate slide layer of polyurethane between the pegs to permit relative movement therebetween. The pegs together with the intermediate layer which may be anchored on one of the pegs form concave and convex bearing areas mating with each other to allow a guided motion in the bend-stretch plane.

U.S. Pat. No. 5,425,777 describes a metallic implantable finger joint that has a biocompatible protective coating and includes both a base member and a protraction member. The base member is formed with a recess and has a protrusion projecting from inside the recess. The protraction member has a hemispherical surface which is slidingly engageable with the recess of the base member. Additionally, the protraction member is formed with a groove which engagingly receives the protrusion from the base member. This engagement is such that when the base member is juxtaposed with the protraction member, the interaction between the protrusion and the groove allows for relative movement between the members in flexion-extension, lateral rotation and pure rotation. The finger joint can also include implant barbs which are selectively engageable with the base member and the protraction member.

U.S. Pat. No. 5,549,690 describes a method for molding a prosthetic CMC thumb joint, and the joint manufactured therefrom, involves anatomically locating the two non-perpendicular and non-intersecting axes of rotation for the joint. The surface of revolution about these two axes, which is a torus, is then used to mathematically model the bearing surfaces of the prosthetic joint.

U.S. Pat. No. 5,728,157 describes a non-resorbable flexible prosthesis that includes a composite made of an elastomeric matrix and a plurality of hydroxylapatite particles dispersed throughout the matrix. The hydroxylapatite particles form about 25%-70%, by weight, of the prosthesis. The matrix is cured to form a flexible prosthesis such that an applied force can distort the flexible prosthesis from its original shape and the flexible prosthesis will substantially return to its original shape when the applied force is removed.

U.S. Pat. No. 5,578,086 describes a non-percutaneous prosthesis, reconstuctive sheeting and composite material which exhibit excellent tissue adhesion, outstanding biocompatibility, moldability, trimability and flexibility are disclosed. The non-percutaneous prosthesis, reconstructive sheeting and composite material can be easily molded into various shapes, trimmed with a scalpel and deformed during prosthesis positioning. The non-percutaneous prosthesis comprises a biocompatible composite material which is made of an elastomeric material and bio-active ceramic or glass particles and has a predetermined shape. The bio-active ceramic or glass particles are dispersed throughout a matrix of the elastomeric material having a predetermined shape, or the elastomeric material is formed to the predetermined shape and the bio-active ceramic or glass particles are coated on a surface of the elastomeric material. In another embodiment, the non-percutaneous prosthesis comprises a base material of predetermined shape and a layer of elastomeric material provided on the base material, wherein a layer of elastomeric material has distributed therein or provided thereon bio-active ceramic or glass particles. The elastomeric material is preferably one of silicone, polyurethane and its derivatives, hydrogel and C-Flex® and, more preferably, is silicone or hydrogel. The bio-active ceramic or glass particles are preferably made of hydoxylapatite. The reconstructive sheeting comprises a biocompatible composite material made of an elastomeric material and bio-active ceramic or glass particles. Also, the present invention provides a biocompatible composite material comprising hydrogel and particles of a bio-active ceramic or glass material. The particles are preferably dispersed throughout a matrix of hydrogel.

U.S. Pat. No. 6,168,626 describes an ultra high molecular weight polyethylene molded article for artificial joints that has molecular orientation or crystal orientation in the molded article, and is low in friction and is superior in abrasion resistance, and therefore is available as components, for artificial joints. Further, the ultra high molecular weight polyethylene molded article for artificial joints can be used as a component for artificial hip joints (artificial acetabular cup), a component for artificial knee joints (artificial tibial insert) and the socket for artificial elbow joints, and in addition to the medical use, it can be applied as materials for various industries by utilizing the characteristics such as low friction and superior abrasion resistance.

U.S. Pat. No. 6,383,223 describes, in an endoprosthesis for a joint, the two interacting joint parts are joined by a cord-type connection piece, which is attached in the vicinity of the body axis of the convex condyle and extends through a longitude groove in the flexion direction of the joint. The connection piece assures a play space between the contact surfaces of joint. It is protected from friction on groove wall by an elevation in concave joint part. An elevation at concave joint part and a depression at convex joint part interact in such a way that the lateral movement play space between depression and elevation determines the freedom of movement with respect to the lateroflexion of the joint. In preferred forms of embodiment, thanks to spherical surfaces at least one pair of corresponding sliding surfaces on the two condyles lie flatly on one another, under load, in any position of the joint.

U.S. Pat. No. 6,386,877 describes the implant that has an anchoring part with an axis, a general cylindrical section and a peripheral surface. The latter is provided, in the generally cylindrical section, with protuberances which are distributed around the axis. At least the majority of these protuberances are elongate and parallel with the axis and have at least one terminal surface which is contiguous with a recess having a base formed by the peripheral surface. In this way, the anchoring part can be pushed into a substantially cylindrical hole in a one such that the implant is immediately anchored in the bone in a stable manner, said implant nevertheless having a high degree of strength.

U.S. patent application Publication No. 2001/0025199 describes the invention that shows an artificial finger joint comprising a convex joint head and comprising a concave joint shell which can be fastened independently of one another with a respective shaft in a bone end and which can be moved in an articulation plane from an extension position with parallel shaft axes into hyperextension position or into an articulation end position. A guide pin projects out of the joint shell in the direction of its shaft axis and protrudes into a pocket of the joint head with the pocket having a first abutment for the guide pin in the hyperextension position. A second abutment between the joint shell and the joint head prevents a tilting of the guide pin and shaft of the joint shell about the first abutment in the hyperextension position.

Notwithstanding the prior art, the present invention is neither taught nor rendered obvious thereby.

### SUMMARY OF THE INVENTION

The present invention relates to a process for creating a polymer film or coating. It includes the steps of: (a) creating a polymer solvent solution at an elevated temperature in excess of 65 degrees Centigrade by combining a polymer, especially a polymer containing a majority of polymer that is polyacrylonitrile, and most especially all polyacrylonitrile, and a solvent selected from the group consisting of dimethyl sulfoxide, dimethyl formamide, NaSCN, CaSCN, nitric acid, ethylene carbonate and mixtures thereof; (b) cooling the resulting solution to a temperature below 35 degrees Centigrade; (c) adding a nonsolvent liquid to said solution, said nonsolvent being selected from the group consisting of water, miscible liquid carbon compounds that do not dissolve said polymer, and combinations thereof: and (d) extracting said solvent and said nonsolvent from said solution to yield a solid polymer film. Preferably, the solution is created having an amount of at least 5%, by weight, of polymer, based on the total weight of the solution of polymer and solvent.

In some embodiments, the present invention process miscible liquid carbon compounds are selected from the group consisting of liquid straight chain hydrocarbons, liquid ring hydrocarbons, liquid ring-straight chain hydrocarbons, and mixtures thereof. These miscible liquid carbon compounds may be selected from the group consisting of glycol, miscible liquid alcohols, liquid ketones, sugars and combinations thereof.

The process first step (a) is conducted processing step in a hot-melt processor is a step selected from the group consisting of extrusion, injection molding, compression molding and hot casting.

The process nonsolvent may be added to said solvent to contain about 40% to 98% of said solvent and about 60% to 2% of said non-solvent, by weight, based on the weight of said solvent and said non-solvent. In preferred embodiments, the solution contains at least 50%, by weight, of solvent, based on the weight of said solvent and non-solvent.

The process extraction may be performed by liquid extraction method.

In some preferred embodiments, the solution is formed in step (a) with granular polyacrylonitrile.

Also, in some preferred embodiments, the solution may be applied to a substrate before, during, or after the cooling step to at least partially coat the substrate.

### BRIEF DESCRIPTION OF THE DRAWINGS

The present invention should be more fully understood when the specification herein is taken in conjunction with the drawings appended hereto wherein:

FIG. 1 shows a flow diagram of a preferred embodiment of the present invention method of processing polymer film, especially polyacrylonitrile.

### DETAILED DESCRIPTION OF THE PRESENT INVENTION

In the industry, there are many instances when there is an advantage, or even need to coat one material over another. Electrical insulation, where a metal wire is coated with rubber or plastic, coating of ships and boats with an antifouling layer, coating products with areas of antislip or antiskid material, medical devices coated for lubricity, hydrogel coatings for drug release, and many other coating uses.

There are also many methods of coating applications. The most widely used is over-extrusion, where molten plastic is applied over a product, e.g., a metal wire. In some specialty products, the plastic can be applied as a monomer and is polymerized during the coating process. Another way to coat is to apply a dissolved polymer in a volatile solvent, which is subsequently evaporated to deposit a dry polymer coat.

The coating process depends on intended product, production cost, environmental impact and other factors. In the case of electrical wire insulation, the most advantageous method would be over-extrusion of molten plastic. In boat coatings, it would be either spray or brush application. Some medical devices, such as catheters and guide wires can be over-extruded as individual pieces. Other medical devices, such as cardiology and peripheral stents, embolization coils, many catheters and wires, are dipped into a polymeric solution containing a volatile solvent, which is then evaporated. Or, as mentioned above, many devices are dipped into a monomer solution and than polymerized either by heat, UV light, or a combination of both.

Both of the last mentioned processes have their disadvantages. Volatile and often toxic solvents have to be evaporated, creating a fire hazard and pollution problem. In a large scale production and when the coating solution may contain as much as 99% solvent, there can be a significant environmental impact.

In the process where the coating starts with monomer and is polymerized after coating, there is also a significant problem. During the polymerization process, up to 20%, or even more free monomer is left after polymerization, depending on the process used. This monomer has to be extracted, because it is usually highly toxic. Both the extraction step and the disposal of diluted monomers add greatly to production cost, and just dumping it is not an option.

To overcome the shortcomings of the prior art processes described, the present invention process is a unique coating and polymer solidifying system, utilizing non-volatile, non-toxic and inexpensive solvent is used. Even though the solvent taken from the group described above, and especially, Dimethylsulfoxide (DMSO), is extracted during the coating process, it's very low toxicity level does not create environmental problem. Since these solvents have a high boiling point, about 180 C for DMSO, it would be difficult to evaporate it from the polymer solution. The polymer layer has to be stabilized by different means to prevent running and streaks, and to maintain a uniform thickness of the coating.

These solvents, especially, DMSO, are highly hydroscopic, which means it has a tendency to pick up moisture from the air and get diluted.

These solvents such as DMSO, as a solvent, are also very sensitive to water content in its mixture. Just a small percentage of water will change DMSO from an excellent solvent into a non-solvent. This process is well described in commonly assigned U.S. Pat. No. 6,593,451 B1, to the present inventor, wherein water and/or other compounds are added to DMSO to create a solvent at higher temperatures and non-solvent at lower temperatures.

In the present invention, the aforesaid process is reversed. The polymer is dissolved in the solvent, preferably DMSO, and under controlled conditions, water vapor is introduced to evenly dilute the DMSO, and thus to stabilize the polymeric layer. This process takes just seconds to minutes, depending on the polymer used, its concentration in DMSO and a relative humidity and temperature of the solidifying environment. The transition of DMSO/water mixture from solvent to non-solvent can be made even sharper by adding other compounds into DMSO, as described in U.S. Pat. No. 6,593,451 B1.

The described process can be used to create very thin coating layers, where the solidifying process takes just seconds, or thick polymeric sheets, or even shaped articles, where it takes hours or days, before the object can be safely handled. The following are examples:

### EXAMPLE 1

10 g of Polyacrylonitrile (PAN), MW of 150,000, was dissolved in 90 g of Dimethylsulfoxide (DMSO) at 80 C. After solution reached room temperature, film of 1 mm thickness was cast on a glass plate. The sample was placed in a humidity chamber, where the relative humidity was 85%. After several minutes PAN solidified, forming a white, microporous structure. DMSO was extracted (removed) in water.

### EXAMPLE 2

A sample was prepared as in Example 1. The sample was dried in an oven at 60 C for 24 hours without an increase in moisture content. The resulting article was an undesirable thin film, brittle with a yellowish tint.

### EXAMPLE 3

Sample was prepared as in example 1.5 mm wide strip was cut from the film and elongated 200% in 90 C water. Sample was dried in oven at 60 C for 24 hours. Dry strip was treated in a mixture of Sulfuric Acid and Glycerol for 45 seconds at 85 C. Resulting article was flexible, strong strip with a highly hydrophilic surface.

### EXAMPLE 4

20 g of PAN was dissolved in 80 g of DMSO at 90 C. After solution reached room temperature, viscous solution was cast on a glass plate. Sample was again placed in a chamber with a relative humidity of 85%. PAN solidified in several minutes, forming a white, microporous structure. DMSO was extracted in water and 5 mm wide strip was cut from the film. Strip was oriented, dried and treated in example 3. Result was a very strong, flexible plastic strip with a lubricous surface.

### EXAMPLE 5

20 g of PAN was dissolved in 80 g of DMSO, as in example 4. When PAN dissolved, 20 g of Barium Sulfate was mixed in. Hot solution was cast on a glass plate and treated as in example 4. Resulting article was tough, strong flexible film, radio opaque with a highly hydrophilic surface.

### EXAMPLE 6

15 g of hydrolyzed PAN was dissolved in 85 g of DMSO at 80 C. When solution reached room temperature, metallic wire was dipped into solution and placed in a chamber with relative humidity at 90%. Hydrolyzed PAN solidified in several minutes. DMSO was extracted in water. Resulting article was a metallic wire coated with a thin layer of hydrogel.

### EXAMPLE 7

Two solutions were prepared:
1)-20 g of PAN in 80 g of DMSO, as in example 4
2)-10 g of hydrolyzed PAN was dissolved in 90 g of DMSO at 80 C.

Hot solution (1) was cast on a glass plate and immediately solution (2) was cast over solution (1). Glass plate was placed in a chamber with a relative humidity 85%. Both layers solidified in minutes, DMSO was extracted in water. Resulting article was a smooth, strong hydrogel over a microporous structure. Both materials were strongly bonded together.

### EXAMPLE 8

10 g of Polymethylmetacrylate (PMMA) was dissolved in 90 g of DMSO at 80 C. Hot solution was cast on a glass plate and placed into a chamber with a relative humidity of 85%. After PMMA solidified, DMSO was extracted in water, sample dried at 70 C for 24 hours. Resulting article was a tough, white micro pores film. Surface of the film was treated in a mixture of Sulfuric Acid and Glycerol to achieve high lubricity and hydrophilicity.

### EXAMPLE 9

10 grams of hydrolyzed PAN was dissolved in 90 grams of 55% sodium thiocyanide (NaSCN) in water at 85 C. After cooling to room temperature, the solution was spread over a glass plate. Using an air brush, a mist of air was applied to the solution. When the water was absorbed, more water was introduced to the solution in the same manner., and this was repeated until the water content in NaSCN reached about 45%, creating a non-solvent from a solvent. The polymer solidified and NaSCN was extracted in water the result was a clear, transparent hydrogel film.

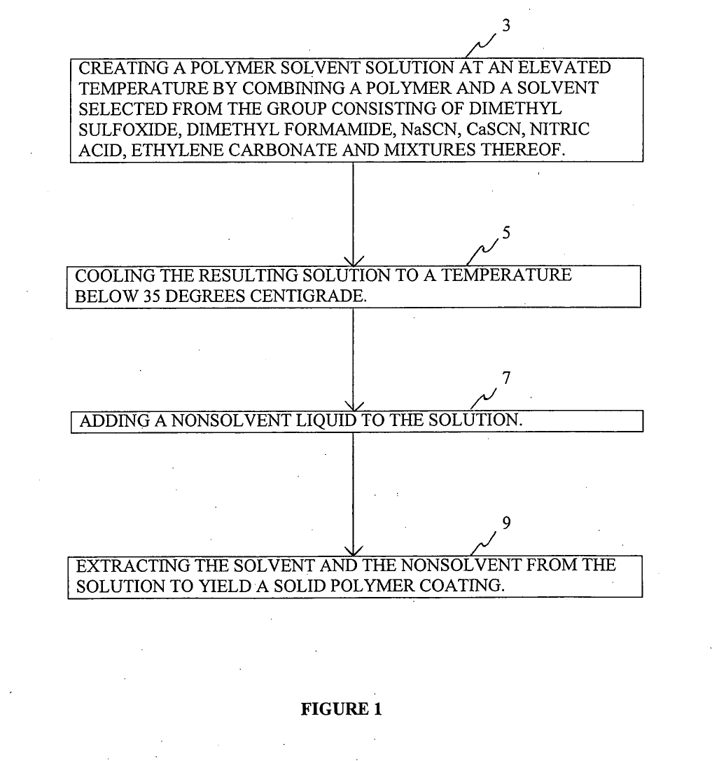

FIG. 1 shows a diagram of the general steps 3, 5, 7, and 9 of the process of the present invention.

Obviously, numerous modifications and variations of the present invention are possible in light of the above teachings. It is therefore understood that within the scope of the appended claims, the invention may be practiced otherwise than as specifically described herein.

1. A process for creating a polymer film, which comprises:
(a) creating a polymer solvent solution at an elevated temperature in excess of 65 degrees Centigrade by combining said polymer and a solvent selected from the group consisting of dimethyl sulfoxide, dimethyl formamide, NaSCN, CaSCN, nitric acid, ethylene carbonate and mixtures thereof;
(b) cooling the resulting solution to a temperature below 35 degrees Centigrade;
(c) adding a nonsolvent liquid to said solution, said nonsolvent being selected from the group consisting of water, miscible liquid carbon compounds that do not dissolve said polymer, and combinations thereof: and, (d) extracting said solvent and said nonsolvent from said solution to yield a solid polymer coating.

2. The process of claim 1 wherein said solution is created having an amount of at least 5%, by weight, of polymer, based on the total weight of the solution of polymer and solvent.

3. The process of claim 1 wherein said miscible liquid carbon compounds are selected from the group consisting of liquid straight chain hydrocarbons, liquid ring hydrocarbons, liquid ring-straight chain hydrocarbons, and mixtures thereof.

4. The method of claim 1 wherein said miscible liquid carbon compounds are selected from the group consisting of glycol, miscible liquid alcohols, liquid ketones, sugars and combinations thereof.

5. The process of claim 1 wherein said first step (a) is conducted processing step in a hot-melt processor is a step selected from the group consisting of extrusion, injection molding, compression molding and hot casting.

6. The process of claim 1 wherein said nonsolvent is added to said solvent to contain about 40% to 98% of said solvent and about 60% to 2% of said non-solvent, by weight, based on the weight of said solvent and said non-solvent.

7. The method of claim 6 wherein said solution contains at least 50%, by weight, of solvent, based on the weight of said solvent and non-solvent.

8. The process of claim 1 wherein said solution is applied to a substrate before said cooling step to at least partially coat said substrate.

9. The process of claim 1 wherein said solution is applied to a substrate during said cooling step to at least partially coat said substrate.

10. The process of claim 1, wherein said solution is applied to a substrate after said cooling step to at least partially coat said substrate.

11. A process for creating a polymer coating, which comprises:
(a) creating a polymer solvent solution at an elevated temperature in excess of 65 degrees Centigrade by combining a polymer containing a majority of polymer that is polyacrylonitrile, and a solvent selected from the group consisting of dimethyl sulfoxide, dimethyl formamide, NaSCN, CaSCN, nitric acid, ethylene carbonate and mixtures thereof;
(b) cooling the resulting solution to a temperature below 35 degrees Centigrade;
(c) adding a nonsolvent liquid to said solution, said nonsolvent being selected from the group consisting of water, miscible liquid carbon compounds that do not dissolve said polymer, and combinations thereof: and,
(d) extracting said solvent and said nonsolvent from said solution to yield a solid polymer film.

12. The process of claim 11 wherein said solution is created having an amount of at least 5%, by weight, of polymer, based on the total weight of the solution of polymer and solvent.

13. The process of claim 11 wherein said miscible liquid carbon compounds are selected from the group consisting of liquid straight chain hydrocarbons, liquid ring hydrocarbons, liquid ring-straight chain hydrocarbons, and mixtures thereof.

14. The method of claim 11 wherein said miscible liquid carbon compounds are selected from the group consisting of glycol, miscible liquid alcohols, liquid ketones, sugars and combinations thereof.

15. The process of claim 11 wherein said first step (a) is conducted processing step in a hot-melt processor is a step selected from the group consisting of extrusion, injection molding, compression molding and hot casting.

16. The process of claim 11 wherein said nonsolvent is added to said solvent to contain about 40% to 98% of said solvent and about 60% to 2% of said non-solvent, by weight, based on the weight of said solvent and said non-solvent.

17. The method of claim 16 wherein said solution contains at least 50%, by weight, of solvent, based on the weight of said solvent and non-solvent.

18. The process of claim 11 wherein said extraction is performed by liquid extraction method.

19. The process of claim 11 wherein said solution is formed in step (a) with granular polyacrylonitrile.

20. The process of claim 11 wherein said solution is applied to a substrate after said cooling step to at least partially coat said substrate.
